(19) United States
(12) Patent Application Publication
(10) Pub. No.: US 2016/0091356 A1
(43) Pub. Date: Mar. 31, 2016

(54) AIR FLOW METER

(71) Applicant: YOW JUNG ENTERPRISE CO., LTD., Kaohsiung City (TW)

(72) Inventor: SHUN-CHI HUANG, KAOHSIUNG CITY (TW)

(21) Appl. No.: 14/499,415

(22) Filed: Sep. 29, 2014

(51) Int. Cl. G01F 15/18

(52) U.S. Cl. CPC G01F 15/185

(57) ABSTRACT

An air flow meter is revealed. It comprises a flow meter body, an intake pipe embedded in a side of the flow meter body, a U-shaped guide way disposed in the flow meter body for connecting the intake pipe, and an outlet disposed at an end of the U-shaped guide way, wherein the outlet has a diameter less than a diameter of the intake pipe.

### BACKGROUND OF THE INVENTION

1. Field of the Invention

The present invention relates to an air flow meter which effectively improves accuracy of measurement of air inflow and increases engine horsepower.

2. Description of Related Art

Conventionally, a vehicle engine requires a proper mixture of fuel and air for combustion to generate power. A general air intake system of a vehicle engine not only cleans an air by an air filter but also drives the cleaned air to flow through an intake pipe, an air flow meter, a throttle and the like, and finally to enter the vehicle engine. Accordingly, an air inflow flowing into the vehicle engine can be detected by the air flow meter, allowing an electronic control unit to calculate how much fuel is needed to inject into the engine. However, air flowing through the intake pipe may collide with each other and generate airflow turbulence, which affects accuracy of air flow meter in detecting the air inflow and affects accuracy of electronic control unit in calculating fuel quantity, leading to a reduced engine performance.

To eliminate detection errors, a U.S. Pat. No. 6,220,090, issued on 24 Apr. 2001, has disclosed an air flow meter, comprising a bypass member having a U-shaped bypass passage, into which part of air flowing through the intake pipe is introduced. Therefore, air flowing through the bypass passage is partially discharged into an air flow passage through an outflow port before joining main air flow in the air flow passage, thereby decreasing air flow velocity and occurrence of turbulence in the bypass passage. As a result, air flow amount of the air flow passage can be measured accurately. However, a decreased air flow velocity causes a reduction of fuel combustion efficiency in an engine and thus decreases engine horsepower.

### SUMMARY OF THE INVENTION

In view of the above-mentioned problems, the object of the present invention is to provide an air flow meter for effectively improving accuracy of measurement of air inflow and increasing engine horsepower.

Disclosed herein is an air flow meter, comprising a flow meter body, an intake pipe embedded in a side of the flow meter body, a U-shaped guide way disposed in the flow meter body for connecting the intake pipe, and an outlet disposed at an end of the U-shaped guide way, wherein the outlet has a diameter less than a diameter of the intake pipe.

According to an embodiment of the present invention, the U-shaped guide way comprises a first portion vertically communicating with the intake pipe, a second portion, and a third portion connecting the first portion in parallel by the second portion and having the outlet at an end thereof

Accordingly, the U-shaped guide way can guide airflow smoothly and prevent airflow turbulence, so as to improve the accuracy of measuring air inflow. Moreover, the air flow meter can increase flow velocity when air flowing through the outlet so that combustion efficiency in an engine is promoted and engine horsepower is increased.

### BRIEF DESCRIPTION OF THE DRAWINGS

FIG. 1 is a stereogram showing an air flow meter according to the present invention;

FIG. 2 is a cross-sectional view showing an air flow meter according to the present invention.

### DETAILED DESCRIPTION OF THE PREFERRED EMBODIMENT

Hereinafter, an exemplary embodiment of the present invention will be described in detail with reference to the accompanying drawings.

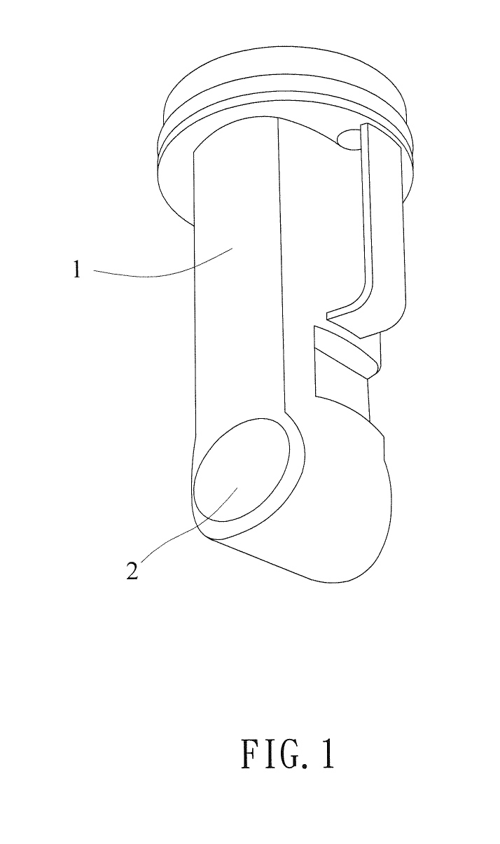

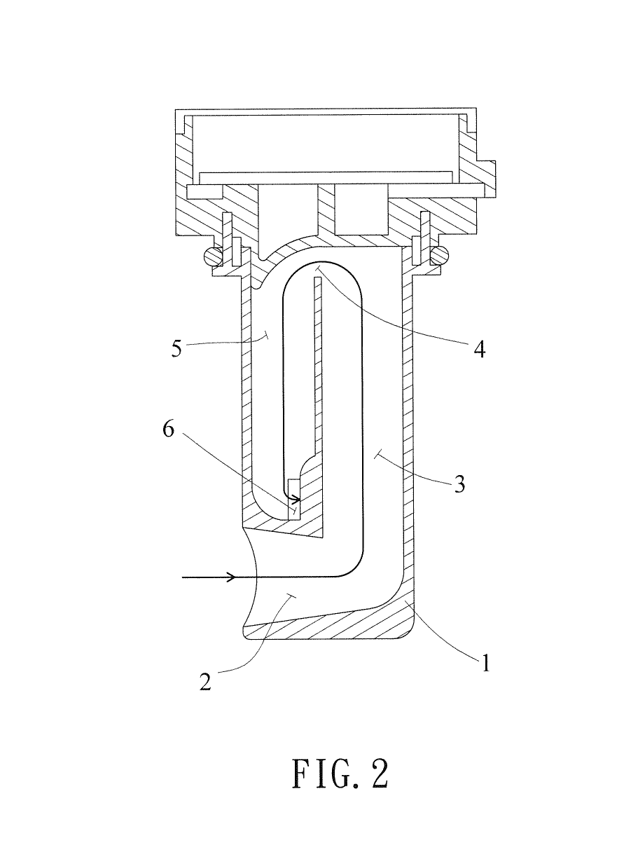

First, referring to FIG. 1 and FIG. 2, an air flow meter is revealed, comprising a flow meter body (1), an intake pipe (2) embedded in a side of the flow meter body (1), a U-shaped guide way comprising a first portion (3), a second portion (4) and a third portion (5) disposed in the flow meter body (1) for connecting the intake pipe (2), and an outlet (6) disposed at an end of the U-shaped guide way, wherein the first portion (3) vertically communicates with the intake pipe (2), the third portion (5) connects to the first portion (3) in parallel by the second portion (4) and has the outlet (6) at an end thereof, and the outlet (6) has a diameter less than a diameter of the intake pipe (2).

Accordingly, a cleaned air from an air filter flows through an air flow meter, throttle and the like by an intake pipe, and finally enters a vehicle engine. In use of an air flow meter according to the present invention, air is allowed to flow into the U-shaped guide way comprising the first portion (3), the second portion (4) and the third portion (5) from the intake pipe (2), and flows out by the outlet (6) at the end of the third portion (5). In such a case, the U-shaped guide way can guide airflow smoothly and prevent airflow turbulence, so as to improve the accuracy of measuring air inflow and allow an electronic control unit to calculate how much fuel is needed to inject into the engine.

Moreover, because the U-shaped guide way of the air flow meter can increase flow velocity when air flowing through the outlet (6) at the end of the third portion (5), combustion efficiency in an engine is promoted and engine horsepower is increased.

According to the above description, in comparison with the traditional technique, an air flow meter according to the present invention has the advantages as following:
1. A U-shaped guide way of the present invention comprises a first portion, a second portion and a third portion, which can correctly guide airflow to make airflow flow smoothly and prevent airflow turbulence. Therefore, the accuracy of measuring air inflow can be improved.
2. A U-shaped guide way of the present invention increases flow velocity when air flowing through the outlet at the end of the third portion so that combustion efficiency in an engine is promoted and engine horsepower is increased.

What is claimed is:

1. An air flow meter, comprising a flow meter body, an intake pipe embedded in a side of the flow meter body, a U-shaped guide way disposed in the flow meter body for connecting the intake pipe, and an outlet disposed at an end of the U-shaped guide way, wherein the outlet has a diameter less than a diameter of the intake pipe.

2. The air flow meter as claimed in claim 1, wherein the U-shaped guide way comprises a first portion vertically communicating with the intake pipe, a second portion, and a third portion connecting the first portion in parallel by the second portion and having the outlet at an end thereof.
